(19) United States
(12) Patent Application Publication
(10) Pub. No.: US 2014/0146518 A1
(43) Pub. Date: May 29, 2014

(54) BACKLIGHT MODULE INCORPORATING LIGHT-DIFFUSION AND LIGHT-CONVERSION PLATE

(71) Applicant: HON HAI PRECISION INDUSTRY CO., LTD., New Taipei (TW)

(72) Inventor: PO-CHOU CHEN, New Taipei (TW)

(73) Assignee: HON HAI PRECISION INDUSTRY CO., LTD., New Taipei (TW)

(21) Appl. No.: 13/749,571

(22) Filed: Jan. 24, 2013

(30) Foreign Application Priority Data
Nov. 29, 2012 (TW) 101144664

(51) Int. Cl. F21V 13/02

(52) U.S. Cl. CPC F21V 13/02
USPC 362/84

(57) ABSTRACT

A backlight module includes an LED, a lens covering the LED and a diffusion and conversion plate placed over the lens. The diffusion and conversion plate has a large amount of light-diffusion particulates and phosphor particulates doped therein. The LED emits blue light towards the diffusion and conversion plate through the lens. The blue light is diffused by the light-diffusion particulates to excite the phosphor particulates to emit yellow light. The yellow light is further diffused by the light-diffusion particulates to uniformly mix with the blue light.

### BACKGROUND

1. Technical Field

The disclosure generally relates to a backlight module, and more particularly, to a backlight module incorporating a light-diffusion and light-conversion plate.

2. Description of Related Art

Nowadays LEDs (light emitting diodes) are applied widely in displays for illumination. A type of display, generally called direct-light display, uses a plurality of LEDs to directly illuminate the screen thereof. The LED often includes a blue light-emitting chip, an encapsulant sealing the chip and a yellow phosphor layer doped in the encapsulant and covering the chip. Thus, blue light emitted from the chip can activate the phosphor to emit yellow light, which mixes with the blue light to produce white light.

However, the blue light emitted from the chip passes through the phosphor layer in different pathways. A part of the blue light having a large light-emergent angle may activate more phosphor in a long pathway to produce more yellow light, while another part of the blue light having a small light-emergent angle may activate less phosphor in a short pathway to produce less yellow light. Thus, the blue light and the yellow light cannot be mixed uniformly, resulting in color aberration of the white light.

Furthermore, a lens may be mounted over the LED for diffusing the white light emitted from the LED. Nevertheless, the lens has different light-refraction levels for the blue light and the yellow light. As a result, the blue light and the yellow light are refracted by the lens to be separated from each other, thereby aggravating the color aberration of the white light. When such white light emitted from the LED is used to be diffused by a diffusion plate to illuminate a screen of a display such as an LCD (liquid crystal display), the color aberration of the white light causes the color of the image shown on the screen to be distorted.

What is needed, therefore, is a backlight module which can address the limitations described.

### BRIEF DESCRIPTION OF THE DRAWINGS

Many aspects of the present embodiments can be better understood with reference to the following drawing. The components in the drawing are not necessarily drawn to scale, the emphasis instead being placed upon clearly illustrating the principles of the present embodiments. Moreover, in the drawing, like reference numerals designate corresponding parts throughout the view.

The only one drawing FIGURE shows a backlight module and a screen in accordance with an embodiment of the present disclosure.

### DETAILED DESCRIPTION

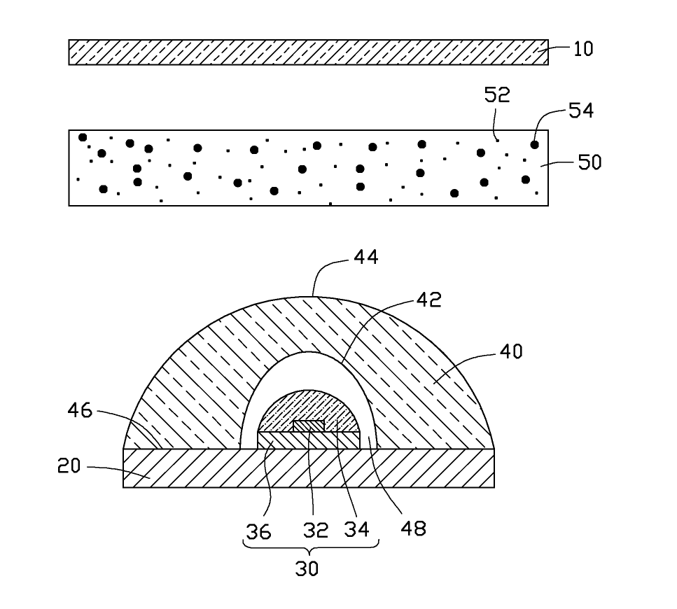

Referring to FIG. 1, a backlight module in accordance with an embodiment of the present disclosure is shown. The backlight module is used for directly illuminating a screen 10 of a display (not shown), such as an LCD (liquid crystal display).

The backlight module includes a board 20, an LED 30 mounted on a top face of the board 20, a lens 40 fixed on the top face of the board 20 and covering the LED 30 and a diffusion and conversion plate 50 above the lens 40.

The board 20 may be a circuit board for supplying power to the LED 30. Preferably, the board 20 may be a metal-core circuit board which has a metal plate sequentially covered by an insulating layer and an electrical route (not shown). Thus, the board 20 can further provide heat dissipation for the LED 30 mounted thereon.

The LED 30 includes a base 36, a light-emitting chip 32 mounted on the base 36 and an encapsulant 34 sealing the chip 32. The base 36 may be made of heat conductive and electrical-insulating materials such as ceramic. The chip 32 may be made of semiconductor materials such as GaN, InGaN, AlInGaN. The chip 32 emits blue light when powered. The encapsulant 34 may be made of transparent materials such as silicone, polycarbonate or polymethylmethacrylate. The encapsulant 34 is attached on the base 36 to seal the chip 32 from an outside environment.

The lens 40 is made of transparent materials such as silicone, glass, polycarbonate or polymethylmethacrylate. The lens 40 has a light-incident face 42, a light-emergent face 44 opposite to the light-incident face 42 and a supporting face 46 connecting the light-incident face 42 and the light-emergent face 44. In this embodiment, the light-incident face 42 is a concave face, the light-emergent face 44 is a convex face, and the supporting face 46 is a flat face. The light-incident face 42 has a curvature larger than that of the light-emergent face 44. The supporting face 46 of the lens 40 is attached on the top face of the board 20 to fix the lens 40 over the LED 30. The lens 40 can diffuse the blue light from the LED 30 towards the diffusion and conversion plate 50.

The diffusion and conversion plate 50 may be made of transparent materials such as polymethylmethacrylate or polystyrene by injection-molding. The diffusion and conversion plate 50 includes a plurality of light-diffusion particulates 52 and phosphor particulates 54 doped therein. The light-diffusion particulates 52 may be made of silicone, polymethylmethacrylate, polystyrene or the like. An average diameter of the light-diffusion particulates 52 may range between 0.5 μm-20 μm. The phosphor particulars 54 may be made of YAG (Yttrium aluminum garnet), silicate or other suitable materials which can emit yellow light when excited by the blue light from the LED 30. Alternatively, the phosphor particulates 54 may also be made of two different materials which can emit red and green light when excited by the blue light from the LED 30. Thus, the red and green light excited from the phosphor particulates 54 can mix with the blue light to generate white light having a high color rendering index. The phosphor particulates 54 may have an average diameter ranging between 1 μm˜20 μm. In this embodiment, the average diameter of the phosphor particulates 54 is larger than that of the light-diffusion particulates 52. The light-diffusion particulates 52 and the phosphor particulates 54 may be dipped in a liquid material of the diffusion and conversion plate 50 before molding the diffusion and conversion plate 50, and then churned together with the liquid material of the diffusion and conversion plate 50. Thus, the light-diffusion particulates 52 and the phosphor particulates 54 are uniformly distributed in the liquid material of the diffusion and conversion plate 50. Finally, the liquid material of the diffusion and conversion plate 50 is injected into a mold and cured therein to form the diffusion and conversion plate 50 containing therein the uniformly distributed light-diffusion particulates 52 and phosphor particulates 54. The light-diffusion particulates 52 and the phosphor particulates 54 are totally doped in an interior of the diffusion and conversion plate 50 without covering any surface of the diffusion and conversion plate 50.

When the LED 30 is activated, the blue light is generated. The blue light passes through the lens 40 towards the diffusion and conversion plate 50 and is diffused beforehand by the lens 40. After entering the diffusion and conversion plate 50, the blue light strikes the light-diffusion particulates 52 and is reflected and refracted by the light-diffusion particulates 52 to diffuse towards various directions. The diffused blue light excites the phosphor particulates 54 to generate yellow light. The yellow light further strikes the light-diffusion particulates 52 to diffuse towards various directions. The blue light and the yellow light can sufficiently mix with each other after multiple striking with the light-diffusion particulates 52. Thus, the white light mixed by the blue light and yellow light in the diffusion and conversion plate 50 can have a high uniformity.

Since the blue light and the yellow light are diffused multiple times by the light-diffusion particulates 52 in the diffusion and conversion plate 50, they can be sufficiently mixed to produce uniform white light. Thus, color aberration of the white light is reduced or even prevented.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A backlight module comprising:
an LED (light emitting diode) emitting a first light;
a lens covering the LED; and
a diffusion and conversion plate comprising phosphor particulates and light-diffusion particulates uniformly distributed therein;
wherein the first light is diffused by the light-diffusion particulates to excite the phosphor particulates to thereby emit a second light, and the second light is diffused by the light-diffusion particulates to mix with the first light to thereby produce white light.

2. The backlight module of claim 1, wherein the first light is blue light, and the second light is yellow light.

3. The backlight module of claim 1, wherein the phosphor particulates have an average diameter larger than that of the light-diffusion particulates.

4. The backlight module of claim 1, wherein the light-diffusion particulates are made of silicone, polymethylmethacrylate or polystyrene.

5. The backlight module of claim 1, wherein the lens comprises a light-incident face and a light-emergent face opposite to the light-incident face, the light-incident face being a concave face and the light-emergent face being a convex face.

6. The backlight module of claim 5, wherein the light-incident face has a curvature larger than that of the light-emergent face.

7. The backlight module of claim 5 further comprising a board supporting the LED, wherein the lens is disposed on the board.

8. The backlight module of claim 7, wherein the lens further comprises a supporting face connecting the light-incident face and the light-emergent face, the supporting face of the lens contacting the board.

9. The backlight module of claim 7, wherein the board is a metal-core circuit board.

10. The backlight module of claim 1, wherein the light-diffusion particulates and the phosphor particulates are totally doped in an interior of the diffusion and conversion plate without covering any surface of the diffusion and conversion plate.

11. A backlight module comprising:
an LED (light emitting diode) emitting blue light;
a lens covering the LED; and
a diffusion and conversion plate comprising light-diffusion particulates and phosphor particulates uniformly doped therein;
wherein the blue light emitted from the LED is diffused by the lens to enter the diffusion and conversion plate, the blue light being further diffused by the light-diffusion particulates to excite the phosphor particulates to emit yellow light, the blue light and the yellow light being diffused by the light-diffusion particulates multiple times to thereby uniformly mix with each other to generate white light before exiting the diffusion and conversion plate.

12. The backlight module of claim 11, wherein the lens comprises a concave light-incident face and a convex light-emergent face opposite to the light-incident face.

13. The backlight module of claim 12, wherein the light-emergent face has a curvature less than that of the light-incident face.

14. The backlight module of claim 11, wherein the phosphor particulates each have a diameter larger than that of each of the light-diffusion particulates.

15. The backlight module of claim 11, wherein the phosphor particulates are totally distributed in an interior of the diffusion and conversion plate without covering any surface of the diffusion and conversion plate.

16. The backlight module of claim 11, wherein the light-diffusion particulates are totally distributed in an interior of the diffusion and conversion plate without covering any surface of the diffusion and conversion plate.

17. The backlight module of claim 11, wherein the LED comprises a light-emitting chip and an encapsulant sealing the light-emitting chip, the encapsulant having no phosphor particulates doped therein.
